(19) United States
(12) Patent Application Publication
(10) Pub. No.: US 2007/0191976 A1
(43) Pub. Date: Aug. 16, 2007

(54) Method and system for modification of audio signals

(76) Inventors: Juha Ruokangas, Hyvinkaa (FI); Mika Koskinen, Piikkio (FI); Vesa Valimaki, Espoo (FI); Henri Penttinen, Espoo (FI); Azadeh Haghparast, Espoo (FI)

Correspondence Address: FASTH LAW OFFICES (ROLF FASTH), 26 PINECREST PLAZA, SUITE 2, SOUTHERN PINES, NC, 28387-4301, US

(21) Appl. No.: 11/376,374

(22) Filed: Mar. 15, 2006

(30) Foreign Application Priority Data
Feb. 13, 2006 (FI) 20060133

(51) Int. Cl. G06F 17/00

(52) U.S. Cl. 700/94

(57) ABSTRACT

The invention is concerned with a method and system for modification of audio signals including pitch-bending of the audio signals in accordance with a control signal. The audio signal consists of an input signal defining the point at which the audio signal is received and of a control signal defining the desired change of the signal pitch. The method comprises digitizing and storing samples of the input signal in a data file memory in such a form that each piece of signal data is placed in a queue having an input pointer that locates the next available storage location and output pointer that locates the next location to read from the queue.

### PRIOR APPLICATION

This application is claiming priority from Finnish patent application no. 20060133, filed 13 Feb. 2006.

### TECHNICAL FIELD

The invention is concerned with a method and a system for modification of audio signals, especially guitar tones, including pitch-bending of the audio signals

### BACKGROUND ART

Electrical signals can be analog, where the signals are carried by continuously varying quantities, and digital, where the signals are presented by a finite set of discrete values (often just two, symbolized by 0 and 1).

For example, when music is processed in electrical instruments, analog signals are first replaced by digital signals, in which form they are processed before they are again converted into analog signals for out playing. The music played by the player is first converted into an electrical analog signal by a microphone, but then the electrical signal is converted into a sequence of zeros and ones by sampling (measuring the intensity of the sound at specific points in time, many thousands of times a second) and quantizing (assigning each intensity to one of a finite number of intensity levels). It is this sequence of zeros and ones that is stored in a memory for further processing.

The signal and its spectrum are then in the form of a series of points which fluctuate over time and in the frequency domain (in practice between 0 Hz and half the sampling frequency). Some part of the original sound signal is naturally lost. The computer only knows the sound at some precise moments. In order to be sure that it will be played properly and without any ambiguity, the sampling has to be very accurate.

There are two very important advantages to digital signals. First, digital signals can be reproduced exactly and second, digital signals can be manipulated easily. Since the signal is just a sequence of zeros and ones, and since a computer can do anything specifiable to such a sequence, the digital signals can be modified as desired by digital signal processing (DSP).

Once the signal has been digitized and resulting data been stored into a data file using an appropriate data structure, the sound can be edited. The samples of the input signal are stored in a data file memory in such a form that each piece of signal data is placed so that a queue of data pieces is formed.

A circular queue is a memory buffer that wraps around, giving the appearance of an infinitely long buffer. Such a queue has an input pointer (that locates the next available storage location) and an output pointer (that locates the next location to read from the queue). When data is written to the queue, the input pointer indicates where in the queue the data will be stored. The pointer is then incremented to the next location. If the pointer reaches the end of the queue, it is repositioned to the beginning of the queue. Likewise, when reading data from the queue, the output pointer indicates the location to read the next piece of data. After the data is read from the queue, the output pointer is incremented, and wrapped around to the beginning of the queue, if necessary. In a MidiEvent structure e.g., the input data is placed and stored in a circular queue with a default size of 512 events:

In order to get rid of unwanted frequencies, filters are used. Filter is a widely used term that applies to any device able to keep or transform partial sound. For example, low pass filters are used to suppress high frequencies which are not audible but annoying for sampling, whereas high pass filters suppress low frequencies.

In practice, digitizing allows a transform of the variation in pressure of the air into a series of numbers that computers understand. A microphone converts pressure variations into electrical signals and a sampler converts the electric signal into numbers. Sampling is an accurate word to describe the process of converting audio from an analogue source into the digital domain. A sampler is a general term and ADC (Analog to Digital Converter) is often used by electricians. The speed at which the sound card can record points (numbers) is called the sampling frequency.

An electrical instrument has a pickup that changes vibrations of a soundboard or strings into an electrical signal. The electrical signal is given off in proportion to pressure. Some materials like certain crystals, ceramics, and polymers exhibit the phenomenon of piezoelectricity. Piezo means pressure in Greek, and piezo materials directly transform mechanical vibrations into electrical signals. Many pickups are based on the piezoelectric effect. The most common pickups are magnetic and piezoelectric.

In music, pitch is the technical term used to describe how high or low a note is. It depends on the frequency (number of vibrations per second) of the sound, which is measured in hertz (Hz). Pitch is thus the musician's term for the frequency of a note and describes how high or low a note sounds.

Pitch bending is the gradual and smooth manipulation of pitch over time. For example, a guitarist going from one note to another has the choice of either simply jumping to the 2nd note (which would be deemed a pitch shift), or gradually bending the string so that the pitch smoothly moves from the 1st note to the 2nd. This is pitch bending.

Also a pitch bend is a continuous control signal which can be applied to synthesized note(s), in keyboard synthesizers usually obtained from a joystick to the left of the lowest key. The pitch of the sound gets raised or lowered as the joystick is moved left or right, respectively.

As it does with music, time plays a fundamental role with acoustics. A very close relationship binds time to space because sound is a wave that propagates into space over time.

Time-scale modification (TSM) of a signal involves the production of a new signal of different duration but with preservation of local periodicity. TSM involves segmentation of the input signal and subsequent rearrangement of these segments in time. E.g. a scaling factor of 2 will stretch the sound file to twice its original length

Time-scale modification of audio signals alters the duration of an audio signal while remaining the signal's local frequency content resulting in the overall effect of speeding up or slowing down the perceived playback rate of a recorded audio signal without affecting the quality, pitch or naturalness of the original signal.

One known pitch-shifting algorithm is based on the re-sampling method presented e.g. in the article Andy Duncan, Dave Rossum, “Fundamentals of Pitch-Shifting”, presented at the 85^{th} Convention of the Audio Engineering Society,(1988 October), preprint 2714. To perform re-sampling, the signal values at arbitrary time instants from a set of samples need to be found. In other words, the signal between samples has to be interpolated. The best interpolation technique for digital audio applications is band-limited interpolation which uses the Sinc function. For every sample in the audio input, the system receives one sample from the control input. The value of the control signal determines the pitch-shifting factor that has a linear relation with the re-sampling factor. The re-sampling factor, in turn, determines the time instant at which the value of the signal must be interpolated. In the next step, the Sinc function is lined up with its peak at this time instant. Then, sample values are multiplied by the corresponding values of the Sinc function and added to each other to produce the signal value. This value is played back, as the pitch-shifted version of the input sample. The pitch-shifting factor is determined by the control signal. Therefore, the re-sampling factor is a function of the control signal.

Since re-sampling the signal changes the length of the signal, a time-scaling method can be used to stretch/truncate the signal back to its original length in which way the signal length is preserved. One such time-scaling technique is related to the ring buffer method presented by Francis Lee in 1979 “Time Compression and Expansion of Speech by the Sampling Method”, JAES Volume 20 Number 9 pp. 738-742; November 1972, which is based on discarding and repeating some segments of the signal to compress or expand the length of the signal, respectively. Since the amplitude and frequency of the signal change (as a function of time), the conventional ring buffer method results in audible artifacts.

In Francis Lee's method, the input and output pointers are acting separately. The input pointer to the buffer is responsible for writing into the buffer and the output pointer reads from the buffer at a different speed depending on the time-scaling factor. Different speeds of the pointers moving around a fixed length buffer, causes them to collide at some locations in the buffer. Collision of the input and output pointers in the buffer results in discontinuity in the output signal which is heard as an audible artifact.

### SUMMARY OF THE INVENTION

The method of the invention for modification of audio signals includes pitch-bending of the audio signals in accordance with a control signal. The audio signal consists of an input signal defining the point at which the audio signal is received and of a control signal defining the desired change of the signal pitch. The method comprises digitizing and storing samples of the input signal in a data file memory in such a form that each piece of signal data is placed in a queue having an input pointer that locates the next available storage location and output pointer that locates the next location to read from the queue. The input signal is processed in order to find the onset point of the input signal. The method performs pitch-shifting of the input signal by re-sampling as a function of the control signal resulting in different speeds for the respective pointers for their moving around the memory thereby changing the signal length. The input signal is modified by time scaling by selecting segments of the input signal to be discarded and repeated in order to preserve the signal length. The method is mainly characterized by measuring the distance between the input pointer and output pointer for each sample in the input and by transferring the output pointer in the memory in accordance with the measured distance in order to avoid colliding of the pointers at any locations.

The system of the invention with which the method can be performed comprises means for producing audio signals, such as a guitar. It also comprises pickup(s) that changes vibrations of an audio signal into an electrical input signal, an analog-to-digital converter for the input signal, and a memory for storing the digitized input signals. The system also comprises a digital signal processing processor with means for control signal analysis and with means to run the algorithm for processing the input signals, a digital-to-analog converter for the output signal, and an amplifier to amplify the output signal, and means for onset-processing of the input signal in order to find the onset point of the input signal.

Preferably, the transferring the output pointer is transferred backward in the memory to a point from which the signal is started to play back if the distance is shorter than a given predetermined amount and by transferring the output pointer forward in the memory behind the input pointer to a point from which the signal is started to play back if the distance is longer than said predetermined amount.

The method of the invention is in first hand intended to be used for guitar tones. Thus, the pitch-shifting algorithm used in the invention is based on re-sampling which changes the signal length. In the invention, the change in the length of the signal while keeping the system low-latency, can be compensated for.

In the pitch-bending algorithm used in the invention, some segments of the signal are repeated or discarded in order to change the length of the signal. In the new method developed, Normalized Filtered Correlation Time Scale Modification (NFC-TSM) was used to find the best point at which signal segments are spliced to each other. NFC-TSM searches for the best splice point in the normalized low-pass filtered signal using a correlation technique.

Onset processing is used in order to have a low-latency system and time-synchronization is performed when an onset is detected. This compensates for a time drift larger than 3 milliseconds. Time-synchronization is performed at detection of an onset by transferring the output pointer forward in the memory behind the input pointer to a point from which the signal is started to play back if the measured distance between the pointers is longer than a predetermined amount. Preferably, time-synchronization is performed if said predetermined distance is more than twice the length of the period of the open string.

Furthermore, Gain and Timbre processing of guitar tones is used as a function of the pitch-bend factor. The timber and gain of the signal change when the pitch is shifted by the manual lever in the electric guitar. The gain and timbre processing simulate these changes when the pitch is shifted by the virtual pitch-bender.

The invention is a real-time system that is able to perform the pitch-bending of tones, especially electric guitar tones in accordance with a control signal with latency of 3 milliseconds, a time-domain pitch-shifting algorithm based on re-sampling has been designed. The new method of the invention preserves the length of the input signal, and uses ring buffer technique [presented e.g. in the article Fairbanks, G., W. L. Everitt, and R. P. Jaeger. “Method for Time or Frequency Compression-Expansion of Speech.” Transactions of the Institute of Radio Engineers, Professional Group on Audio AU-2 (1954): 7-12. Reprinted in G. Fairbanks, Experimental Phonetics: Selected Articles, University of Illinois Press, 1966 and in the article Francis F. Lee, Time Compression and Expansion of Speech by the Sampling Method, JAES Volume 20 Number 9 pp. 738-742; November 1972] and an overlap and add algorithm [presented e.g. in Udo Zölzer, Digital Audio Effects, ISBN: 0-471-49078-4, Hardcover 554 pages, February 2002] in a new way.

The signal length is preserved by repeating or discarding some parts of the signal. In order to follow all the changes in the signal, an onset detector is used to find the onsets in the signal and jump to the new event with a latency of e.g. 3 milliseconds after it occurs.

When the pitch of the signal is shifted down, in the traditional electric guitar, with the manual lever, the level of the string vibrations is attenuated and the timbre changes to a slightly darker sound, i.e., the higher frequencies are attenuated. These phenomena can be simulated with an automatic gain controller (AGC) and an equalizer (EQ) which are controlled by the pitch-shifting factor. Parameters for the automatic gain controller and equalizer will be obtained from measurements. The digital signal processing processor therefore preferably further comprises an equalizer for timbre processing of the pitch-bent signal as a function of the pitch-bend factor in order to simulate signal changes as a result of the pitch-shifting, a pick-up filter and an Automatic Gain Controller (AGC).

Moreover, the control signal obtained from a stretch-sensor attached to the system is analyzed. The unprocessed signal is noisy, and is processed in a time interval of almost 3 milliseconds. Therefore, an averaging technique along with a curve-fitting method is used to make the signal smooth.

In the invention, the traditional manual lever is replaced by a sensor and the pitch bending is performed by DSP algorithms.

Modeling of the resonant behavior of different manual levers is, however, possible. Manual levers tend to vibrate slightly after a rapid release of the lever, i.e., the lever does not perfectly move to its rest position after quickly releasing the lever from an offset position, but resonates slightly. This causes an audible effect in the guitar signal. In contrast, the electromechanical lever producing the control signal is quite rigid and does not resonate as much as some manual levers. A lever resonance-model simulates this resonant behavior of the manual lever with a digital filter. The proper digital filter to be used in the invention is a resonator with its parameters tuned according to a real manual lever to control the decay time of the output signal. In other words, the centre frequency and decay time of the filter are matched with the target response. This way the resonating mass-spring system of the manual lever is modeled with a digital filter and its effect on the output signal is simulated properly. In the signal chain the filter modeling the resonant behavior of the manual lever is placed as a last block before output. In respect to FIG. 2 it is placed after the AGC block (FIG. 2 being described in the detailed description section).

In the following, the invention is illustrated by means of an example of an advantageous embodiment by referring to figures. The detailed description is for illustrative purposes only and the intention is not to restrict the invention to the details of the following presentation. The following example is for example concerned with the guitar, but the inventive idea can equally well be implemented in other connections for e.g. other electrical music instruments.

### BRIEF DESCRIPTION OF THE DRAWINGS

FIG. 1 shows a general prior art system for producing electrically manipulated music

FIG. 2 depicts a block diagram of the whole inventive system

FIGS. 3a-3b present the idea of the pitch-shifting algorithm of the invention more in detail

### DETAILED DESCRIPTION

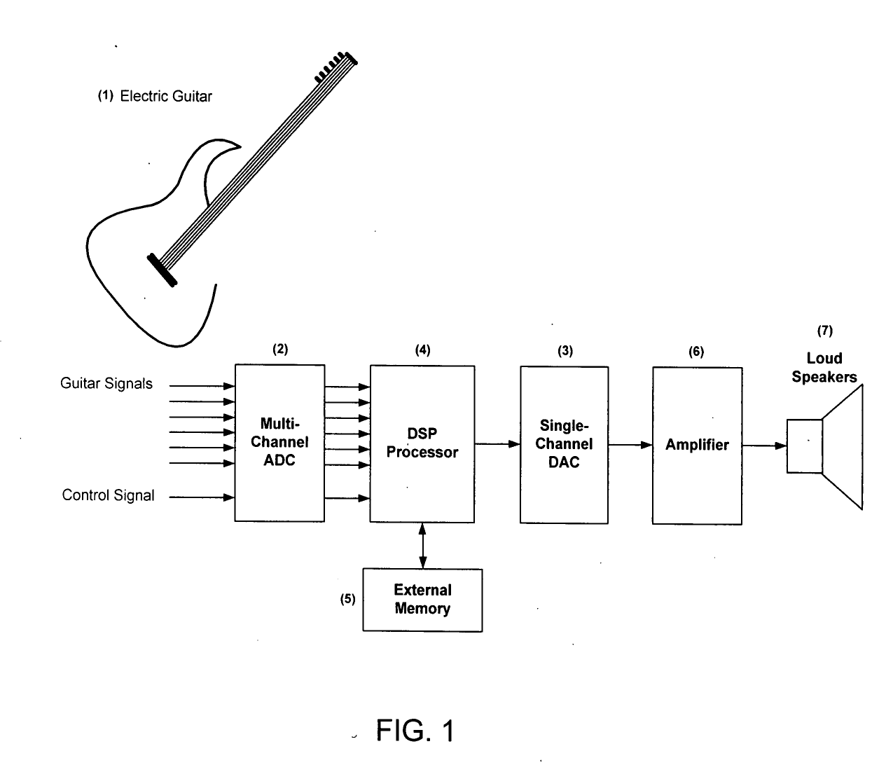

FIG. 1 shows a general prior art system for producing electrically manipulated music with an electric guitar.

In FIG. 1, the electrical guitar 1 has six piezo pick-ups 8. A pickup changes the vibrations of the guitar strings into an electrical signal. The material in the pickup (such as eg. piezo materials) directly transforms mechanical vibrations into electrical signals. The system also comprises a multi-channel analog-to-digital converter (ADC) 2 for input signals, a single-channel digital-to-analog converter (DAC) 3 for output signals, a DSP processor 4 to run the related algorithm for processing the input signals, an external memory 5 for storing the digitized input signals, an amplifier 6 to amplify the output signal and loud speakers 7.

Each string on the guitar is connected to a piezo pick-up. There are six piezo pick-ups which are generating signals to be processed. These signals are conducted to the input of an analog-to-digital converter (ADC) through 6 channels. A control signal is produced by a related manual control device, such as a joystick, installed on the guitar and will be conducted to the analog-to-digital converter as well. It is with the joystick the player expresses how the music should be played. In the DSP processor, an algorithm manipulates the signals in order to form desired output signals, which are generated and which are passed to a digital-to-analog converter (DAC). For the algorithm to function properly, the DSP processor needs an external memory for storing the intermediate data sampled from the audio input signal. After conversion to analog format, the output signal is amplified and played back via loudspeakers.

The samples of the input signal are digitized and stored in the memory 5 in a data file in such a form that each piece of signal data is placed in a queue having an input pointer that locates the next available storage location and an output pointer that locates the next location to read from the queue. The input signal is modified by time scaling resulting in different speeds for the respective pointers for their moving around the memory,

The invention is implemented on the DSP processor part of FIG. 1.

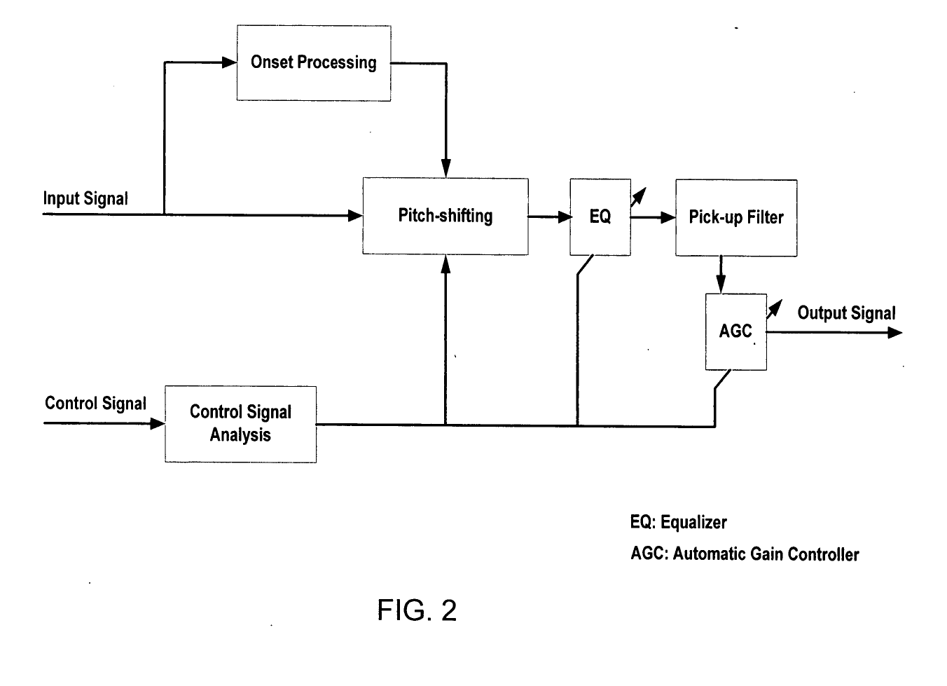

FIG. 2 depicts a block diagram of the inventive DSP processor system in its whole. The digitized audio signal consists of an input signal defining the point at which the audio signal is received and of a control signal defining the desired change of the signal pitch. Thus, FIG. 2 presents how the input signal 9 and the control signal 10 of the audio signal are processed.

The Digital Signal Processing (DSP) processor (represented by reference number 4 in FIG. 1) comprises means 11 for control signal analysis, means 12 for onset processing, means 13 to run a pitch-shifting algorithm, an equalizer 14 for timbre processing of the pitch-bent signal, a pick-up filter 15, and an Automatic Gain Controller (AGC) 16 for producing an output signal 17. The output signal is then amplified in an amplifier 6 (presented in FIG. 1) and played back via loud speakers 7 (presented in FIG. 1).

A control signal is generated by a sensor attached to the system of FIG. 1 in accordance with the position of the joystick of the guitar. The received control signal is noisy. As a result of periodic noise in the control signal, some wobbling can be audible in the perceived pitch. Therefore, the received control signal obtained from the sensor circuit should be processed to have a smooth waveform. Digital signal processing methods can be used for this purpose.

The received control signal is a pulse train which has a period of about 31 samples (1423 Hz). Looking at the control signal, one can realize that the negative part of the signal contains more information than the positive part. Hence, the first step is to separate the negative part of the signal.

As discussed above, the control signal is noisy. One way to get rid of the noise is averaging. The average of the signal is calculated in each period of the pulse train without considering zero values. If we look at the average values of periods in a longer time interval, say 100 periods, we will notice that the average values over periods are also changing unsteadily. The reason is that in each period, there are some points whose values have a big difference with the real level of the signal. In the next stage, the average value of the signal is calculated once again ignoring those values whose variance with the previous average is greater than a threshold. The threshold is determined based on experiments. Then, in each period all the sample values are replaced by the calculated average value.

Even averaging the control signal over single periods does not smooth the signal as much as desired. The next step is to smooth the signal with a curve fitting technique. There are different kinds of curve fitting techniques. Because the control signal has a very low frequency, a linear curve fitting technique is suitable for our application. First, the derivative of the computed average points is calculated. This derivative signal is used to determine the number of points which should be considered to fit the line between. Finally, the curve fitting technique is applied.

The onset-processing block 12 in FIG. 2 is responsible for finding the onset in the input signal. In other words, it should be able to detect any noticeable change in the amplitude, pitch or timbre of the sound, since all the changes happening in the signal the same time as they occur have to be heard.

The samples of the input signal are stored in the invention into a data file memory in such a form that each piece of signal data is placed so that a queue of data pieces is formed having an input pointer (that locates the next available storage location) and an output pointer (that locates the next location to read from the queue). When data is written to the queue, the input pointer indicates where in the queue the data will be stored. Likewise, when reading data from the queue, the output pointer indicates the location to read the next piece of data.

As it can be deduced from the pitch-shifting algorithm, because of the time modification technique (time scaling), the location of the output pointer to the buffer is changing depending on the pitch-shifting factor. For this reason, the distance between the output and the input pointers is not constant and it is highly probable that when an onset occurs, the output pointer has a distance more than 3 milliseconds with the input pointer. This way we can not hear the new pluck with a latency of less than 3 milliseconds. To avoid this problem, if an onset occurs, the output pointer should jump forward, just behind the input pointer with a distance equal or less than 3 milliseconds so that we can hear the onset as it occurs.

The Onset-detector 12 consists of a high-pass filter, since most onsets in guitar tones contain high-frequency components. Then, the energy of the high-pass filtered signal is calculated using an integrator. The energy of the high-passed filtered signal is compared at certain time intervals. Any considerable change in the energy of the high-pass filtered signal is marked as an onset. However, a sudden change in the amplitude of the signal also brings about the perception of an onset. Thus, the energy calculation and comparison are also done for the signal itself without high-pass filtering.

Because this application should be low-latency, a high resolution onset detector is needed. That is, the onset should be able to be detected within 3 milliseconds. For this reason, very short intervals for energy calculation and comparison are needed. Using intervals of short lengths makes the comparison impossible, since the energy of the signal changes periodically. To handle this problem, instead of comparing the energy of the signal at certain time intervals, the values of the envelope (characteristics of the note) of the energy are compared. This operation is done for both the high-pass filtered signal and the input signal.

The means 13 to run a pitch-shifting algorithm performing resampling and time-scaling (to preserve the signal length). The pitch-shifting factor is determined by the control signal. Therefore, the re-sampling factor is a function of the control signal.

The time-scaling technique of the invention is based on discarding and repeating some segments of the signal to compress or expand the length of the signal, respectively.

The input pointer to the buffer is responsible for writing into the buffer and the output pointer reads from the buffer at a different speed depending on the time-scaling factor. Different speeds of the pointers moving around a fixed length buffer, would normally cause them to collide at some locations in the buffer with discontinuity in the output signal heard as a result. This problem is, however, avoided in this invention.

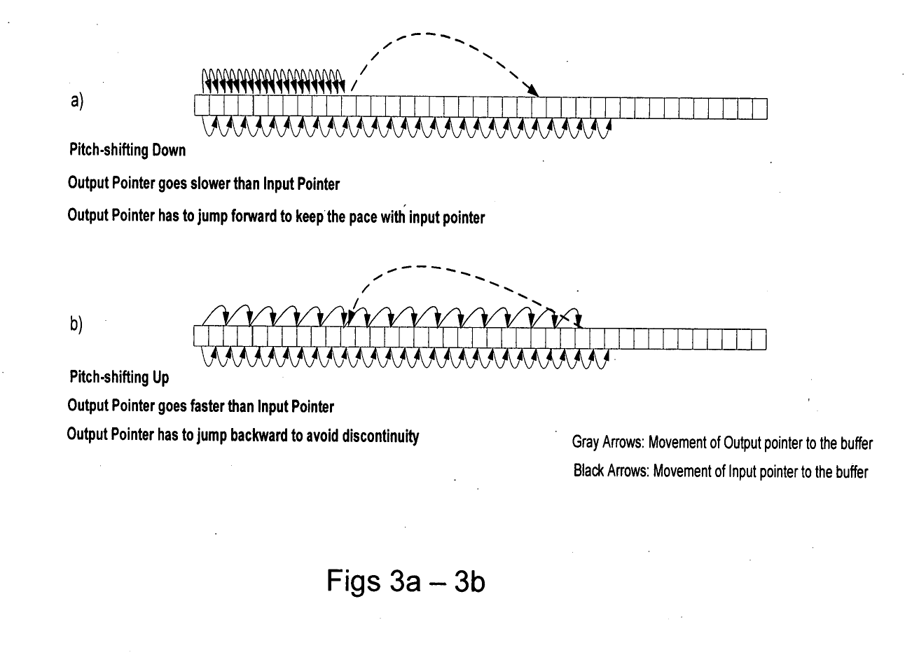

The output pointer to the buffer is handled in such a way that it never collides with the input pointer and also always keeps the pace with the input pointer to follow the changes in amplitude and frequency. Thus, for every sample in the input, the distance between input and output pointers is measured. If the distance is shorter than a certain amount the output pointer jumps backward in the buffer and starts playing back the signal from that point. On the other hand, if this distance is more than a given amount the output pointer jumps forward, behind the input pointer. It should be noticed that the hop lengths can not be very long, since we are aiming to follow the changes in the signal with a short latency. FIG. 3 shows how the input and output pointers behave in the two different cases; when the pitch is shifted down in FIG. 3a and up in FIG. 3b.

In FIG. 3a, the output pointer (illustrated with the arrows 18 under the queue of information pieces) goes slower than the input pointer (illustrated with the arrows 19 above the queue of information pieces). Therefore, the output pointer has to jump forward to keep the pace with the input pointer, which is illustrated with reference number 20 in FIG. 3a.

In FIG. 3b, the output pointer (illustrated with the arrows 18 under the queue of information pieces) goes faster than the input pointer (illustrated with the arrows 19 above the queue of information pieces). Therefore, the output pointer has to jump backward to keep the pace with the input pointer, which is illustrated with reference number 20 in FIG. 3b.

However, when jumping to a new point, the periodicity of the signal must not be broken. Hence, a correlation technique has to be used to find the right point. The correlation function used in this invention is AMDF (Average Magnitude Difference Function) that has shown better results than e.g. the cross-correlation technique, which also could be used. Before starting to search for the best splicing point using AMDF, the signal is passed through a low-pass filter and then normalized. Low-pass filtering causes the signal to become smoother. This way, it is easier to find the best splicing point. By normalizing the low-pass filtered signal, the effect of the level of the signal in finding the best point will be eliminated, because the priority here is to preserve the periodicity of the fundamental frequency of the signal. The best splicing point is where the AMDF has its minimum value in the whole search region. Having found the most suitable point, the output pointer can start playing back the signal from this point. To avoid amplitude discontinuity, a cross-fading function is used to splice the previous sound segment with the new segment.

An equalizer 14 is used for timbre processing of the pitch-bent signal. The DSP processor also comprises a pick-up filter 15, and an Automatic Gain Controller (AGC) for producing an output signal. The timber and gain of the signal change when the pitch is shifted by the manual lever in the electric guitar. The gain and timbre processing simulate these changes when the pitch is shifted by the virtual pitch-bender.

1. Method for modification of audio signals including pitch-bending of the audio signals in accordance with a control signal, the audio signal consisting of an input signal defining the point at which the audio signal is received and of a control signal defining the desired change of the signal pitch, the method comprising the steps of
a) digitizing and storing samples of the input signal in a data file memory in such a form that each piece of signal data is placed in a queue having an input pointer that locates the next available storage location and output pointer that locates the next location to read from the queue,
b) processing of the input signal in order to find the onset point of the input signal,
c) pitch-shifting of the input signal by re-sampling as a function of the control signal resulting in different speeds for the respective pointers for their moving around the memory thereby changing the signal length,
d) modifying the input signal by time scaling by selecting segments of the input signal to be discarded and repeated in order to preserve the signal length, and
e) measuring the distance between the input pointer and output pointer for each sample in the input and by transferring the output pointer in the memory in accordance with the measured distance in order to avoid colliding of the pointers at any locations.

2. The method according to claim 1 wherein the method further comprises transferring the output pointer backward in the memory to a point from which the signal is started to play back if the distance is shorter than a given predetermined amount and by transferring the output pointer forward in the memory behind the input pointer to a point from which the signal is started to play back if the distance is longer than said predetermined amount.

3. The method according to claim 2 wherein the method further comprises using a correlation function for finding the best splice point to which the pointers are transferred in each case.

4. The method according to claim 3 wherein the method further comprises the correlation function used is the Average Magnitude Difference Function (AMDF).

5. The method according to claim 4 wherein the method further comprises the minimum value of the AMDF in the search region is selected as the best splicing point.

6. The method according to claim 5 wherein the method further comprises using a cross-fading function to splice the previous sound segment with the new segment.

7. The method according to claim 1 wherein the method further comprises performing time-synchronization at detection of an onset.

8. The method according to claim 7 wherein the method further comprises performing the time-synchronization at an onset by transferring the output pointer forward in the memory behind the input pointer to a point from which the signal is started to play back if the measured distance between the pointers is distance is longer than a predetermined amount.

9. The method according to claim 8 wherein the method further comprises performing the time-synchronization if said predetermined distance is more than twice the length of the period of the open string.

10. The method according to claim 7 wherein the method further comprises performing the onset detection for both input signal and its high-pass filtered signal.

11. The method according to claim 10 wherein the method further comprises comparing the values of envelope of the calculated energy of the signals in order to detect the onset.

12. The method according to claim 1 wherein the method further comprises gain and timbre processing of the signal as a function of the pitch-bend factor in order to simulate signal changes as a result of the pitch-shifting.

13. The method according to claim 1 wherein the method further comprises the audio signal to be modified is a guitar tone.

14. The method according to claim 1 wherein the method further comprises stimulating the resonant behavoring of a manual lever with a digital filter by tuning the parameters so that the centre frequency and decay time of the filter are matched with the target response.

15. A system for modification of audio signals, comprising:
means for producing audio signals consisting of an input signal defining the point at which the audio signal is received and of a control signal defining the desired change of the signal pitch,
one or more pickups that changes vibrations of an audio signal into an electrical input signal,
an analog-to-digital converter for the input signal,
a memory for storing the digitized input signals, the memory having a data file in such a form that each piece of signal data is placed in a queue having an input pointer that locates the next available storage location and output pointer that locates the next location to read from the queue,
a digital signal processing processor with
means for control signal analysis,
means to run an algorithm for processing the input signals, a digital-to-analog converter for the output signal, and an amplifier to amplify the output signal, the algorithm performing pitch-shifting of the input signal by re-sampling as a function of the control signal and selecting segments of the input signal to be discarded and repeated in order to preserve the signal length, which is changed as a result of the re-sampling,
means for onset-processing of the input signal in order to find the onset point of the input signal, and
the algorithm measuring the distance between the input pointer and output pointer for each sample in the input and by transferring the output pointer in the memory in accordance with the measured distance in order to avoid colliding of the pointers at any locations.

16. The system according to claim 15 wherein the algorithm uses a correlation function for finding the best splice point to which the pointers are transferred in each case.

17. The system according to claim 16 wherein the means running an algorithm uses the Average Magnitude Difference Function (AMDF) as the correlation function.

18. The system according to claim 15 wherein the digital signal processing processor further comprises an equalizer for timbre processing of the pitch-bent signal as a function of the pitch-bend factor in order to simulate signal changes as a result of the pitch-shifting.

19. The system according to claim 15 wherein the digital signal processing processor further comprises a pick-up filter.

20. The system according to claim 15 wherein the digital signal processing processor further comprises an Automatic Gain Controller (AGC).

21. The system according to claim 15 wherein the means for producing audio signals is a guitar.
